(19) United States
(12) Patent Application Publication
(10) Pub. No.: US 2008/0204236 A1
(43) Pub. Date: Aug. 28, 2008

(54) Embedded medical data system and method

(76) Inventor: Oded Shlomo Kraft-Oz, Haifa (IL)

Correspondence Address: GE HEALTHCARE;c/o FLETCHER YODER, PC, P.O. BOX 692289, HOUSTON, TX, 77269-2289, US

(21) Appl. No.: 11/709,615

(22) Filed: Feb. 22, 2007

(51) Int. Cl. G06F 19/00; B65D 85/00; G08C 17/00

(52) U.S. Cl. 340/572.1; 206/459.5; 705/3

(57) ABSTRACT

Systems and methods are provided for utilizing imaging agent or patient information encoded on a respective information tag, such as a Radio Frequency Identification (RFID) tag. In the context of imaging agent information, the encoded information tag may include such information as the dose, the manufacturer, the manufacturing date, the manufacturing time, or the batch number. An imaging system may include a reader that acquires the encoded information from the respective tag and uses that information in image acquisition or processing or which associates the information with some or all of the acquired images.

### BACKGROUND

The invention relates generally to systems and methods for tracking the use of imaging agents in imaging procedures, and more particularly to systems and methods for tracking and recording the use of a particular imaging agent that has been used to generate imaging data and/or for purposes of processing resulting data.

In recent years, considerable advances have been made in medical diagnostic equipment and systems, particularly imaging systems. Such imaging systems encompass a range of modalities, each characterized by the physics involved in acquiring and processing image data. At present, medical diagnostic imaging modalities include magnetic resonance imaging (MRI) systems, X-ray systems, both digital and conventional film-based, computed tomography (CT) systems, ultrasound systems, positron emission tomography (PET) systems, nuclear imaging, and so forth.

Regardless of the particular modality, medical diagnostic systems are often a key element in the diagnosis and treatment of disease and ailments. Such diagnostic imaging systems may utilize imaging agents that, when administered to a patient, facilitate the acquisition of useful image data of a patient's tissues, organs, or other areas of interest. The imaging agents may include, for example, radioactive agents or contrast agents. Particularly in the case of radioactive imaging agents, healthcare practitioners may exercise caution when administering these agents to patients in order to avoid administering an incorrect dosage or to avoid contamination by any remaining agent left in the bottle. Because of such concerns, imaging agents are often stored in individual containers as single-use unit doses that may circumvent concerns about dosage or contamination.

A single-use unit dose container of an imaging agent may include various identifying information, including the name of the agent, the total dose amount, the batch number, the manufacturing date and time, and so forth. However, beyond the name of the imaging agent, the information on the dose container does not typically become part of the record for either the imaging data produced or for the patient to whom the dose was administered. Generally, the dose container is disposed of after administration to the patient, making record keeping difficult. Further, because the dose container may be contaminated, it is generally not desirable to retain the container in order to make detailed records of its administration to the patient. However, detailed information about the unit dose may provide useful information to the clinicians analyzing the imaging data from the patient to whom the dose was administered. For example, information about the manufacturing date and/or time of the dose may provide an indication of the total radiation dose received by the patient. Additionally, specific information about a unit dose may allow clinicians to perform clinical comparisons of imaging results for doses prepared by different manufacturers, by the same manufacturer, or for doses from a certain manufacturing batch or batches.

### BRIEF DESCRIPTION

The present technique generally relates to a system and method for utilizing information about an imaging agent in a corresponding imaging procedure. A scanner or reader may acquire encoded information from an information tag disposed on a container, such as a package, vial or syringe, that holds a dose of an imaging agent. The reader may pass the encoded information to a processor for decoding the information and using the information in the imaging process, such as for enabling, disabling, or configuring an image acquisition process, for configuring processing of the acquired image data, and/or for association with images generated from the acquired image data. For example, by associating the imaging agent information with the generated images, information about the imaging agent that may be useful in evaluating the images may be readily accessed by a healthcare practitioner and/or by the camera and/or processing units. Patient information read off of the same or a similar tag may also me accessed and processed in this manner.

In accordance with one aspect of the present technique, a method is provided for configuring an imaging operation. The technique includes the act of acquiring information from an encoded information tag using a tag reader. At least one aspect of an imaging operation is automatically configured based on the acquired information.

In accordance with a further aspect of the present technique, an imaging system is provided. The imaging system includes an imager adapted to acquire image data and system control circuitry configured to control operation of the imager. The imaging system also includes a reader adapted to acquire encoded information related to at least one of an imaging agent or a patient. The imaging system further includes data acquisition circuitry configured to receive at least the image data and data processing circuitry configured to process at least the image data. At least one of the system control circuitry, the data acquisition circuitry, or the data processing circuitry is configured to automatically use the encoded information in their operation.

In accordance with another aspect of the present technique, a container adapted to hold an imaging agent is provided. The container includes a container vessel configured to hold at least one dose of an imaging agent. The container also includes an information tag attached to the container vessel. The information tag encodes information used to configure at least one of acquisition or processing of image data acquired after administration of the imaging agent.

In accordance with an additional aspect of the present technique, a method is provided for processing image data. The method includes the act of acquiring information from an encoded information tag using a tag reader associated with an imaging system. The information is automatically associated with one or more images acquired by the imaging system

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of an exemplary system for use in acquiring patient image data and imaging agent information in accordance with the present technique;

FIG. 2 is an exemplary imaging agent radio frequency information tag and reader in accordance with the present technique;

FIG. 3 is a flow chart depicting a process of acquiring patient information and imaging agent information in conjunction with an imaging procedure in accordance with the present technique; and

FIG. 4 is an exemplary unit dose of an imaging agent including a removable information tag that may be placed on a patient wristband in accordance with the present technique.

### DETAILED DESCRIPTION

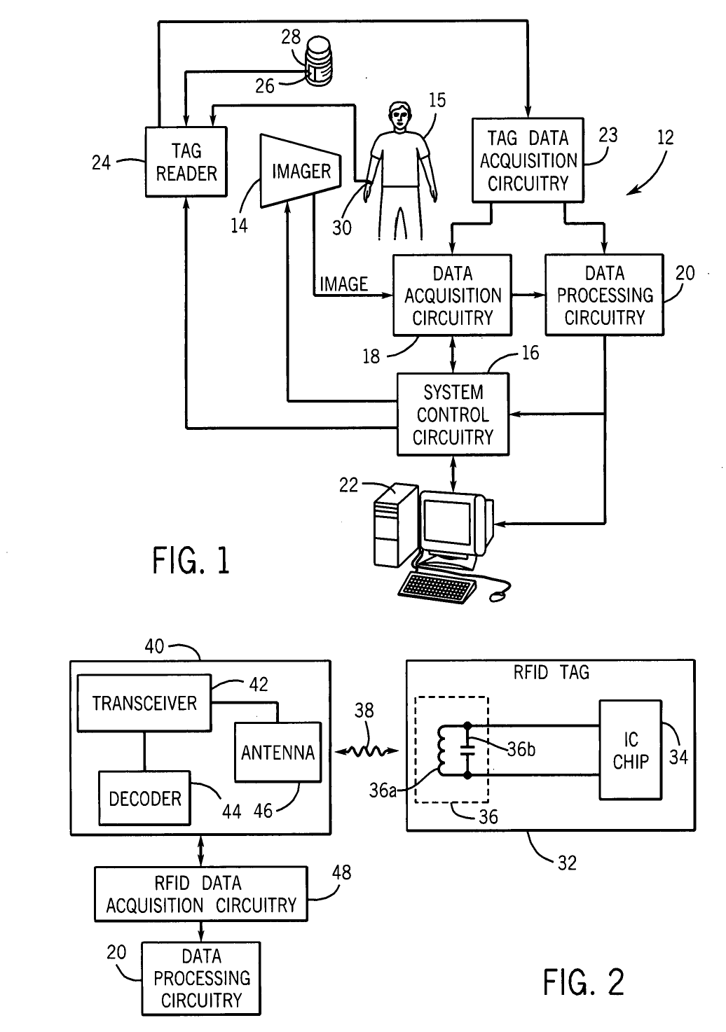

Referring now to FIG. 1, a medical imaging system, designated generally by the reference numeral 12, is illustrated. In general, the system 12 may include any of a variety of non-invasive imaging systems of various modalities and generally includes some type of imager 14 that detects signals, either emitted by the patient 15 or transmitted through the patient 15 and converts the signals to useful image data. As described more fully below, the imager 14 may operate in accordance with various physical principles for creating the image data. In general, however, image data indicative of regions of interest in a patient 15 are created by the imager 14 either in a conventional support, such as photographic film, or in a digital medium. For simplicity, the present examples are generally directed to imaging systems 12 based on digital imaging technology, such as digital image acquisition, processing, storage and so forth. Such digital imaging modalities may include X-ray imaging systems, computed tomography (CT) imaging systems, positron emission tomography (PET) systems, fluorography systems, mammography systems, tomosynthesis systems, sonography systems, infrared imaging systems, nuclear imaging systems, thermoacoustic systems, magnetic resonance imaging (MRI), and so forth. As will be appreciated by those of ordinary skill in the art, the preceding list of digital imaging modalities is not exhaustive and is merely illustrative of the types of digital imaging technologies that may benefit from the present technique. Further, other non-digital imaging techniques and modalities (such as imaging onto analog or photographic media) or techniques having both digital and non-digital aspects (such as systems where analog images are digitized prior to processing and storage), may also benefit from the present technique.

In the present exemplary embodiment, the imager 14 operates under the control of system control circuitry 16. The system control circuitry 16 may include a wide range of circuits, such as radiation source control circuits, timing circuits, circuits for coordinating data acquisition in conjunction with patient or table of movements, circuits for controlling the position of radiation or other sources and of detectors, and so forth. The imager 14, following acquisition of the image data or signals, may process the signals, such as for conversion to digital values, and forwards the image data to data acquisition circuitry 18. The data acquisition circuitry 18 may perform a wide range of initial processing functions, such as adjustment of digital dynamic ranges, smoothing or sharpening of data, as well as compiling of data streams and files, where desired. In addition, in the case of analog media, such as photographic film, the data acquisition circuitry may also include circuitry involved in the subsequent digitization and processing of the analog media. The data is then transferred to data processing circuitry 20 where additional processing and analysis are performed. Depending on the modality, the data processing circuitry 20 may perform substantial analyses of data, ordering of data, sharpening, smoothing, feature recognition, and so forth. In addition, in some embodiments, the data processing circuitry 20 may apply textual information to an image or images, or may apply certain notes, annotations, or patient identifying information. In certain embodiments, the imager 14, system control circuitry 16, data acquisition circuitry 18, and data processing circuitry 20 may all be encompassed in a single apparatus.

Ultimately, the image data is forwarded to some type of operator interface 22 for viewing and analysis. While operations may be performed on the image data prior to viewing, the operator interface 22 is at some point useful for viewing reconstructed images based upon the image data collected. The images may also be stored in short or long term storage devices, for the present purposes generally considered to be included within the interface 22 or in a picture archiving communication systems. The image data can also be transferred to remote locations, such as via a network. It should also be noted that, from a general standpoint, the operator interface 22 may afford control of the imaging system 12, typically through interface with the system control circuitry 16. Moreover, it should also be noted that more than a single operator interface 22 may be provided, for example, to provide different operator interfaces for image acquisition operations and for image processing or review operations. Accordingly, an imaging scanner or station may include an interface which permits regulation of the parameters involved in the image data acquisition procedure, whereas a different operator interface may be provided for manipulating, enhancing, and viewing resulting reconstructed images.

The system 12 also includes a tag reader 24 that is adapted to acquire encoded information from an information tag 26 disposed, in one embodiment, on the imaging agent dose container 28 of an imaging agent (such as a contrast agent or radiopharmaceutical). The information tag 26 may include any information about the imaging agent, including the type of imaging agent, the dose, the manufacturer, the manufacturing date, the manufacturing time, and batch number, and/or any relevant storage and/or preparation information.

The tag reader 24 may also be adapted to read a patient information tag 30 that may be worn by the patient 15 or otherwise associated with the patient (such as on a patient medical chart). The patient information tag 30 may include demographic information about the patient 15, including patient medical history and/or patient identification information. Additionally or alternatively, patient information tag 30 may include a pointer to a local or remote data set having some or all of: demographic information about the patient, patient medical history and/or patient identification information.

As used herein a “tag,” both in the context of the patient information tag 30 and/or the information tag 26 should be understood to encompass various types of information encoding structures that can be attached to or otherwise associated with the patient 15 or the imaging agent. One example of such a tag is an radio frequency identification tag (RFID) tag, as discussed below, which may be attached to a patient 15, to an identification bracelet or garment worn by the patient 15, to a chart associated with the patient 15, to a container used for storing an imaging agent, or to a package used to store or ship such containers. Other types of tags are also envisioned, however, such as paper, plastic, or metal tags that magnetically and/or optically store encoded information related to the corresponding patient 15 and/or image agent. Such tags may also be associated with the corresponding patient 15, imaging agent, or associated structure, such as by mechanical, adhesive, or other means.

In embodiments in which the patient 15 is enrolled in a clinical trial, the imaging agent tag 26 or the patient information tag 30 may also include information identifying the clinical trial and/or instructions for incorporating the imaging agent information and the image data into the trial results. The tag reader 24 may pass the encoded information from the imaging agent tag 26 and/or the patient tag 30 to tag data acquisition circuitry 23 and/or data processing circuitry 20 for further processing and/or storing with resulting data.

FIG. 2 illustrates an exemplary embodiment in which the imaging agent information tag 26 and/or the patient information tag 30 are provided as a RFID tag 32. However, it should be understood that in other embodiments, the information tag 26, 30 may be provided in other formats that may be read or scanned by the tag reader 24, such as a barcode or any other suitable encoded information tag. In the presently depicted embodiment, the RFID tag 32 may include a microchip 34 attached to an antenna 36. The RFID tag 32 may either be active (with an integrated power source) or passive (without an integral power source). Suitable RFID tags 32 are commercially available from various manufacturers, such as Texas Instruments (Plano, Tex.).

The tag 32 is capable of communicating with any suitable tag reader 24. In an embodiment where the imaging agent information tag 26 and/or the patient information tag 30 are provided as RFID tags 32, as depicted in FIG. 2, the tag reader 24 may be provided as an RFID reader 40. As depicted, communication between the RFID tags 32 and the RFID reader 40 is illustrated by two-way arrow 38. In the depicted embodiment, the tag 32 comprises an rf inlay formed by an antenna 36 and an IC chip 34. The antenna 36 includes an inherent inductance 36a and capacitance 36b which in part define the resonant frequency of the tag 32. The IC chip 34 may include an internal battery, circuitry and logic for processing signals received through the antenna 36 and generating and providing signals to the antenna 36 for transmission, and a storage memory (not shown). In embodiments in which the tag 32 is an active RFID tag, the tag 32 may use power provided by the internal battery to generate and transmit a signal from antenna 36.

In embodiments employing passive RFID tags 32 as the information tag 26 or 30, the passive tag may be powered by the field generated by a corresponding RFID reader 40. Read-only tags are typically passive and are programmed with data that, generally, is not modified by a reader 40. A reader 40 may include a transceiver 42 and decoder 44, and, optionally, an antenna 46, and may be configured either as a handheld or a fixed-mount device. The reader 40 emits radio waves in ranges of approximately one inch to 100 feet or more, depending upon its power output and the radio frequency used. The RFID reader 40 may incorporate or otherwise communicate with RFID data acquisition circuitry 48 and/or data processing circuitry 20, such as in a computer, workstation or other processor-based system with which the reader 40 is configured to communicate.

As noted above, the RFID reader 40 may be fitted with an antenna 46, the size depending on the communication distance required. The electromagnetic field produced by the antenna 46 can be constantly present when multiple tags are expected continually, or the field can be activated by a sensor device, such as a proximity or motion sensor, if constant interrogation is not desired. In a passive RFID implementation, the antenna 46 activates the RFID tag 32 and transfers data by emitting wireless pulses. Often the frequencies of these pulses are in the range of 125 kHz, 13.56 MHz or 800-900 MHz, depending upon the desired use and the distance between the tag and the RFID station. An RFID reader 40 can read information stored on the RFID tag 32 and, in certain embodiments, update this RFID tag 32 with new information. The application software specifically designed for such reading and writing tasks may be part of the RFID data acquisition circuitry 48 or the data processing circuitry 20. In certain embodiments, the tag data acquisition circuitry 23, such as RFID data processing circuitry 48, may be part of the tag reader 24, or may be associated with another device. In an exemplary implementation, when an RFID tag 32 passes through the electromagnetic field generated by the reader 40, it detects the reader's activation signal. The reader 40 decodes the data encoded in the tag's integrated circuit chip 34, and the data is relayed to the host computer for processing.

The communication between the tag 32 and the RFID reader 40 is initiated once the tag 32 successfully receives an interrogation signal transmitted by the RFID reader 40. Once the tag 32 receives the interrogation signal, the circuitry and logic stored on the IC chip 34 decodes the interrogation signal and transmits a response signal to the reader 40. The response signal may encode any of the information stored in the storage memory of the IC chip 34, such as information about a patient or an imaging agent administered to the patient.

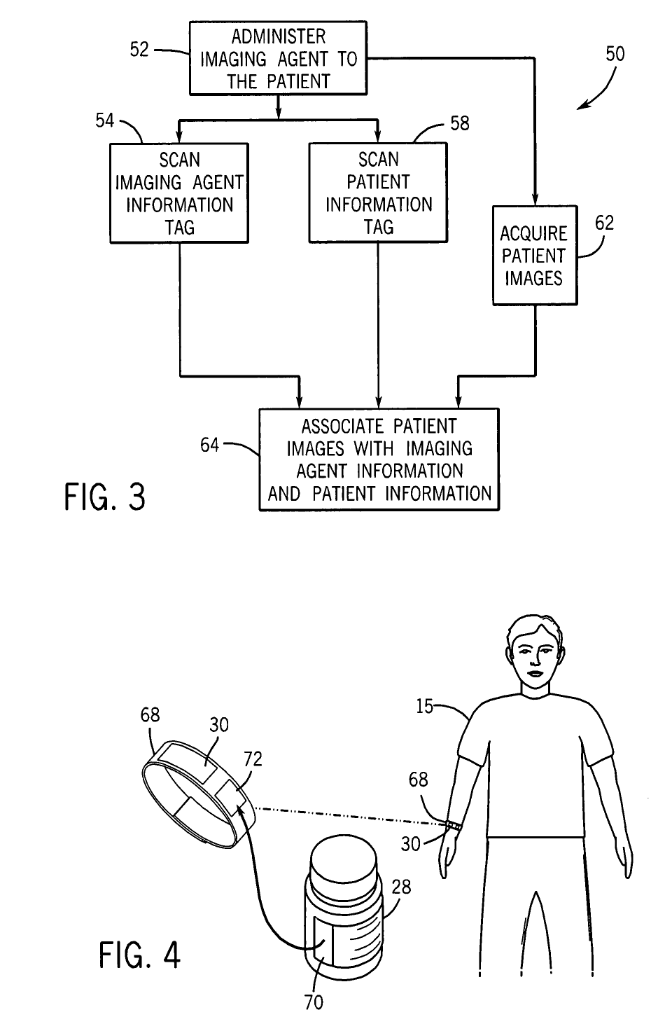

FIG. 3 illustrates a flow chart 50 describing steps for linking a patient's imaging examination results to imaging agent information acquired using an information tag 26 as discussed herein. In this implementation, an appropriate dose of an imaging agent, which may be a radioactive imaging agent or contrast agent, is administered (block 52) to the patient. Exemplary imaging agents may include Myoview™, Omnipaque™, Omniscan™, Optison™, or Visipaque™ (all available from GE Healthcare). An information tag 26 associated with the imaging agent bottle 28 is scanned (block 54) by a tag reader 24 in order to acquire (block 56) the imaging agent information. In certain embodiments, the information tag 26 may be scanned while still on the bottle 28, after which the imaging agent bottle 28 may be stored or disposed of, as appropriate. In other embodiments, the information tag 26 may be separated from the bottle 28, either prior to or after administration of the imaging agent to the patient 15, and scanned without regard to the location or disposition of the bottle 28. For example, in one implementation, the information tag 26 is removed from the bottle 28 upon administration of the imaging agent to the patient 15. The information tag 26 may then be associated with the patient 15 in some manner, such as by attachment to the patient or to an article worn by the patient, so that the information tag 26 can be scanned (block 54) in conjunction with the imaging examination. If the patient has an information tag 30, it may also be scanned (block 58) by the tag reader 24 to acquire (block 60) the patient information. The information tag 26 and the patient information tag 30 may be the same or different types of tags. For example, the information tag 26 may be an RFID tag 32, while the patient information tag 30 may be a barcode found on a patient identification bracelet or patient chart.

After administration of the imaging agent, the patient may have images, such as bone images, tissue images, or other medical images, taken (block 62) by an imager 14 that is part of a medical device. The patient images may be acquired at step 62 either before, after, or concurrently with the scanning and acquisition of imaging agent information (blocks 54 and 56) and/or patient information (blocks 58 and 60). The imaging agent information and the patient information may then be linked (block 64) to the acquired patient images, such as by the data processing circuitry 20 described above. The acquired imaging agent and/or patient information may be displayed with the image data or images derived from the image data, such as on a display device or printed output. Alternatively, the acquired imaging agent and/or patient information and images may be recorded as part of a digital record of the examination, such as in a medical or picture archive, as part of the patient's medical history, or as part of a clinical study. Such techniques may ensure that the imaging agent information is properly acquired with a reduced possibility of human error in recording the information. For example, such automated or semi-automated information acquisition concerning the imaging agent may allow timely disposal of used containers and bottles without sacrificing detailed record-keeping concerning the imaging agent.

In other embodiments, the information encoded on the information tag 26 may be used to disable the imager 14 if, for example, the identity of the imaging agent acquired by the tag reader 24 does not match the intended imaging agent indicated for the imager 14 and/or patient 15. For example, imaging protocol or imaging agent prescription information may be encoded on the patient information tag 30 or otherwise available to the workstation 22 or data processing circuitry 20, such as from an intra-hospital network. Alternatively, the system control circuitry 16 may recognize imaging agents suitable for use with the imager 14 based on a look-up table or other mechanism accessible to the system control circuitry 16. In such embodiments, if an imaging agent is identified from the imaging agent information tag 26 that is not the indicated agent for the patient 15 or that is not suitable for use with the imager 14, the system control circuitry 16 may prevent operation of the imager 14 and/or may notify an operator of the discrepancy. Optionally, the system control circuitry 16 may alert the operator that the pharmaceutical in imaging agent bottle 28 has expired by comparing the actual time and date to a manufacturing time and date of the pharmaceutical in imaging agent bottle 28, as determined from the information tag 26. In some embodiment, the time of manufacture of a radiopharmaceutical, as determined from the information tag 26, is used to evaluate whether a radiopharmaceutical retains sufficient activity for a successful imaging examination, taking into account the original activity, the needed activity for the procedure and the timing of the imaging.

The information on the tag 26 can also be used to disable certain functionality in the workstation 22 and/or to automatically establish parameters or protocols for image acquisition and/or processing. For example, if the tag 26 indicates the administration of a certain imaging agent, such as Myoview™, a Myoview™ protocol may be enabled on the imaging system 12, such as on the workstation 22 and/or on the system control circuitry 16. Such an imaging protocol may optimize operation of the imager 14, the data acquisition circuitry 18, and/or the data processing circuitry 20 for acquisition and/or processing of images of a patient 15 who has been treated with the respective imaging agent. In this manner the automated acquisition of information from the information tag 26 may be used to activate certain imaging parameters and/or protocols on the imaging system 12 while preventing the activation of other imaging protocols during the time that patient images are being acquired.

FIG. 4 illustrates an embodiment in which an imaging agent information tag 26 is a removable information tag 70. The removable tag 70 may be transferable to, for example, a patient wristband 68, or any other patient-wearable device. As shown, the patient wristband 68 may also include a patient information tag 30. The removable tag 70 may include an adhesive layer or any suitable attachment mechanism to attach the tag 70 to the patient wristband 68. Such an embodiment provides the advantage of allowing the patient information tag 30 and the imaging agent information tag 70 to be provided in one location for later scanning by a tag reader 24. For example, a patient 15 may be administered an imaging agent in a separate room from where the imager 14 is located. In such an embodiment, the information tag 70 may be applied to the wristband of the patient 15 prior to the patient entering the imaging room. Once in the imaging room, the removable tag 70 that includes encoded information relating to the imaging agent may be scanned as described herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for configuring an imaging operation, the method comprising:
acquiring information from an encoded information tag using a tag reader;
automatically configuring at least one aspect of an imaging operation based on the acquired information.

2. The method of claim 1, wherein automatically configuring at least one aspect of the imaging operation comprises automatically establishing one or more imaging parameters for the imaging operation.

3. The method of claim 1, wherein automatically configuring at least one aspect of the imaging operation comprises automatically selecting an image acquisition protocol for an imaging system based upon at least an imaging agent identity determined from the acquired information.

4. The method of claim 1, wherein the acquired information pertains to at least one of an imaging agent to be used in the imaging operation or a patient being imaged by the imaging operation.

5. The method of claim 1, wherein acquiring the information comprises at least one of scanning a radio frequency or scanning a barcode.

6. The method of claim 1, comprising:
detaching the encoded information tag from an imaging agent dose container; and
attaching the encoded information tag to a structure worn by a patient.

7. An imaging system comprising:
an imager adapted to acquire image data;
system control circuitry configured to control operation of the imager;
a reader adapted to acquire encoded information related to at least one of an imaging agent or a patient;
data acquisition circuitry configured to receive at least the image data; and
data processing circuitry configured to process at least the image data;
wherein at least one of the system control circuitry, the data acquisition circuitry, or the data processing circuitry is configured to automatically use the encoded information in their operation.

8. The imaging system of claim 7, wherein the system controller is configured to automatically establish one or more image acqusition parameters or to apply an imaging protocol based upon the encoded information.

9. The imaging system of claim 7, wherein the data processing circuitry is configured to automatically associate some or all of the encoded information with one or more images generated from the image data.

10. The imaging system of claim 7, wherein the data processing circuitry is configured to automatically establish one or more image processing parameters based upon the encoded information.

11. The imaging system of claim 7, wherein the imager comprises an X-ray imager, a positron emission tomography imager, a computed tomography imager, an ultrasound imager, a nuclear medicine imager, or a magnetic resonance imager.

12. The imaging system of claim 7, wherein the reader comprises at least one of a radio frequency identification reader or a barcode reader.

13. The imaging system of claim 7, wherein the encoded information relates to at least one of an identity of the imaging agent, a manufacturing date of the imaging agent, a manufacturing time of the imaging agent, a batch number of the imaging agent, a dose identification of the imaging agent, or a dose amount of the imaging agent.

14. A container adapted to hold an imaging agent, comprising:
a container vessel configured to hold at least one dose of an imaging agent;
an information tag attached to the container vessel, wherein the information tag encodes information used to enable, disable, and/or configure at least one of acquisition or processing of image data or features associated with acquisition or processing of image data.

15. The container of claim 14, wherein the information tag is designed to be removed from the container vessel.

16. The container of claim 14, wherein the information encoded by the information tag comprises at least one of an identity of the imaging agent, a manufacturing date of the imaging agent, a manufacturing time of the imaging agent, a batch number of the imaging agent, a dose identification of the imaging agent, or a dose amount of the imaging agent.

17. The container of claim 14, comprising at least one dose of the imaging agent.

18. The container of claim 14, wherein the imaging agent comprises one of a contrast agent or a radiopharmaceutical.

19. The container of claim 14, wherein the encoded information is used to automatically establish one or more image acquisition parameters or an image acquisition protocol.

20. The container of claim 14, wherein the encoded information is used to automatically establish one or more image processing parameters or an image processing protocol.

21. A method for processing image data, the method comprising:
acquiring information from an encoded information tag using a tag reader associated with an imaging system;
automatically associating the information with one or more images acquired by the imaging system.

22. The method of claim 21, wherein the information pertains to at least one of an imaging agent to be used in the imaging operation or a patient being imaged by the imaging operation.

23. The method of claim 21, wherein acquiring the information comprises at least one of scanning a radio frequency or scanning a barcode.

24. The method of claim 21, comprising:
detaching the encoded information tag from an imaging agent dose container; and
attaching the encoded information tag to a structure worn by a patient.

25. The method of claim 21, wherein the information relates to at least one of an identity, a manufacturing date, a manufacturing time, a batch number, a dose identification, or a dose amount of an imaging agent.

26. The method of claim 21, wherein the information relates to or points to at least one of a patient medical history, a patient identification, or demographic information about a patient.
